(19) United States
(12) Patent Application Publication
(10) Pub. No.: US 2006/0150193 A1
(43) Pub. Date: Jul. 6, 2006

(54) Signal management in operations with multiple waits

(76) Inventors: Edward J. Sharpe, Los Gatos, CA (US); James Alan Woodward, Merrimack, NH (US); Jenchang Ho, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/031,227

(22) Filed: Jan. 6, 2005

(51) Int. Cl. G06F 9/46

(52) U.S. Cl. 718/107

(57) ABSTRACT

A computer-implemented method for handling a first signal received at a client context is disclosed. The method includes saving a signal mask bitmap into a saved signal mask bitmap when the client context enters a wait mode, thereby preserving data in the signal mask bitmap. The method also includes masking the first signal in the signal mask bitmap, thereby causing the client context to defer taking action on the first signal. The method additionally includes masking the first signal in a pending signals bitmap, thereby permitting the first signal to be tracked as pending with the client context.

### RELATED APPLICATIONS

The invention is related to a commonly-assigned patent application entitled “UNIX SIGNAL INTERRUPTION BEHAVIOR IN SERVER” Attorney Docket No. 200400104-1, by the same inventors herein, filed herewith.

### BACKGROUND OF THE INVENTION

In certain operating systems, an application thread may at times need to make a system call, which requires the client context to make a request of the server context to carry out some operation. While the client context is waiting for the server context to carry out the operation, the client context is usually put into a wait (sleep) mode. While in the wait mode, the client context may be interrupted by a signal (event), which requires its attention. The handling of this interrupting signal or other such interrupting signals, which may be received while the client context is in its wait mode, is the subject of this application.

To facilitate discussion, FIG. 1 shows a block diagram of the execution environment in which an application thread may be interrupted from its wait state by a signal. There are shown two nodes 102 and 104, which may be implemented on different computer systems or on the same computer system. Application thread 106 executing on node 102 makes a system function call 108, which moves from the application space 110 into the kernel space 112. As part of the system function call 108, the operating system kernel makes a call into the kernel client code (or context) 114. The client code 114 makes a request 120 into server code (or context) 122, which is shown executing in the kernel space 156 on node 104 in FIG. 1.

The server context 122 carries out the requested operation and responds with a response 124. During the time that server context 122 carries out the requested operation, client context 114 is typically put into a wait (or sleep) state. During the time that client 114 is in its sleep state, a signal may be received which requires the attention of client context 114. This interrupting signal may represent a signal generated by a signal call 128 made by another application thread 130, for example. This signal call 128 generates a signal 132 into client context 114, which interrupts client context 114 from its wait state. The interrupting signal may also be generated by a server 140 (which generates a signal 142), or interrupt handler code 144 (which generates a signal 146), for example.

When client context 114 is interrupted by a signal (such as signal 132) from its wait state, client context 114 may need to contact server context 122 in order to inform server context 122 of the newly received signal 132. Server context 122 then cleans up its in-progress states, either by completing the pending operation or by aborting it, and responds with a response 124, which allows client context 114 to clean up its in-progress states to take action on the received signal 132.

During the time that server context 122 takes to clean up its in-progress states, yet another signal (such as signal 142) may interrupt client context 114. This presents a complication, as there are now multiple signals received by client context 114, all of which need to be properly handled.

FIG. 2 shows one prior art approach to handling an interrupting signal, explained in the context of thread signal states for the application thread (such as application thread 106). In FIG. 2, there is shown an signal mask bitmap 202, representing the bit map of signals that should be held pending (masked) by the application thread. For example, signals 2, 5, 13, and 35 are shown to be masked in application thread 106 (since their associated bits are set in signal mask bitmap 202). The bits in signal mask bitmap 202 may be set by the application thread, for example.

Furthermore, there is shown a pending signals bitmap 204 representing the signals currently pending with the application thread 106. A signal may be masked but not pending (e.g., signal 35), which indicates that the application thread does not wish to be interrupted with that signal if and when that signal arrives. A signal may be pending but not masked (e.g., signal 37), which indicates that the signal will be serviced by the application thread at its next opportunity. A signal may be both pending and masked, which indicates that the signal is pending but action on the signal is deferred by the application thread. As shown, signals 2, 5, and 13 are both pending and masked. Bits in the pending signal bitmap (204) may be set by any source of signals (including another thread 130, a server 140, or an interrupt handler 144).

Each signal may also have an associated signal queue in which instances of the same signal are queued up when received. For example, each member of queue 206 (e.g., 206A or 206B) may have a different action associated with it although both queue members 206A and 206B are both instances of the same signal (2). Queue may have zero membership (as in the case of signal 5). In this case, only one action will be taken irrespective of how many instances of signal 5 are received. Alternatively, a queue may have a different number of members (as in the case of signal 13, which queue has 4 members).

A current signal area 210 tracks the signal currently being serviced by operations undertaken by the server context. In the example of FIG. 1, suppose signal 19 has been handled by operations undertaken by server context 122 in response to a request from client context 114. If another signal, such as signal 20, interrupts client context 114 while client context 114 was waiting for a response from sever context 122, the current signal area 210 now tracks signal 20 (as shown in FIG. 2). As can be appreciated, signal 19 is no longer tracked, which disadvantageously causes application thread 106 to lose track of signal 19.

FIG. 3 illustrates an alterative prior art technique, whereby multiple signals received after client context 114 enters its wait state are tracked. In the prior art implementation of FIG. 3, an additional bitmap 302 is employed to track the saved signals (i.e., the signals that have been sent to server context 122). If a signal is sent to the server context for servicing, its associated bit is set in the saved signals bitmap 302. As shown, the bits for signals 19 and 20 are set in FIG. 3, indicating that signals 19 and 20 have been sent to the server context 122 and that the client context 114 is currently in its wait mode waiting for server context 122 to respond. The current signal area 304 shows zero to denote that there are no current signals that are being acted upon by client context 114.

There are, however, certain disadvantages associated with the approach of FIG. 3. Since the saved signals data is saved in a bitmap hidden from the general signal delivery mechanism of the operating system, the general signal delivery mechanism may not see that signal 19 is currently pending while delivering signal 20 to client context 114. In some cases, the fact that signal 19 is pending may impact how signal 20 is delivered, how it is handled, or even whether it is handled at all. For example, signal 20 may have in its semantics an action to change the state of any pending signal, and the fact that pending signal 19 is hidden from the general signal delivery mechanism would result in signal 19 state being unchanged, i.e., an erroneous result. Furthermore, certain applications such as debuggers depend on the states of signals being open for analysis. The fact that the pending state of signal 19 is hidden from view may cause such programs to give erroneous outputs.

Further, multiple instances of the same signal may be received while the client context is in the wait state. For example, multiple instances of signal 19 may be received by client context 114 while client context 114 is in a wait state waiting for server code 122 to respond to the request sent when the first instance of signal 19 is received. Each time a new instance of signal 19 is received by client instance 114, client instance 114 will again inform server instance 122 of the receipt of another instance of signal 19, and server instance 122 would respond to allow client instance 114 to set the bit in the saved signals bitmap 302. Thus, although server context 122 would perform the same action with the receipt of every instance of the same signal and nothing would change, the repeated cycles of informing the server context, responding to the client context, and setting the bitmap bit are still needlessly performed.

### SUMMARY OF INVENTION

The invention relates, in an embodiment, to a computer-implemented method for handling a first signal received at a client context. The method includes saving a signal mask bitmap into a saved signal mask bitmap when the client context enters a wait mode, thereby preserving data in the signal mask bitmap. The method also includes masking the first signal in the signal mask bitmap, thereby causing the client context to defer taking action on the first signal. The method additionally includes masking the first signal in a pending signals bitmap, thereby permitting the first signal to be tracked as pending with the client context.

In another embodiment, the invention relates to an article of manufacture comprising a program storage medium having computer readable code embodied therein, the computer readable code being configured for handling a first signal received at a client context. The article of manufacture includes computer readable code for saving a signal mask bitmap into a saved signal mask bitmap when the client context enters a wait mode, thereby preserving data in the signal mask bitmap. The article of manufacture also includes computer readable code for masking the first signal in the signal mask bitmap, thereby causing the client context to defer taking action on the first signal. The article of manufacture additionally includes computer readable code for masking the first signal in a pending signals bitmap, thereby permitting the first signal to be tracked as pending with the client context.

In yet another embodiment, the invention relates to a computer-implemented method for handling a first signal received at a client context. The client context resides in a kernel space of an operating system of a client computer node. The method includes copying a signal mask bitmap into a saved signal mask bitmap when the client context enters a wait mode, thereby preserving data in the signal mask bitmap. The method further includes receiving the first signal. If the first signal is a signal requiring the client context to request handling by a server context, the method includes forwarding the first signal to a server context for handling, masking the first signal in the signal mask bitmap, thereby causing the client context to defer taking action on the first signal, and masking the first signal in a pending signals bitmap, thereby permitting the first signal to be tracked as pending with the client context. The client context ignores, when the first signal is tracked in the pending signals bitmap, subsequently received signals pertaining to instances of the first signal.

These and other features of the present invention will be described in more detail below in the detailed description of various embodiments the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a block diagram of the execution environment in which an application thread may be interrupted from its wait state by a signal.

FIG. 2 shows one prior art approach to handling an interrupting signal, explained in the context of thread signal states for the application thread.

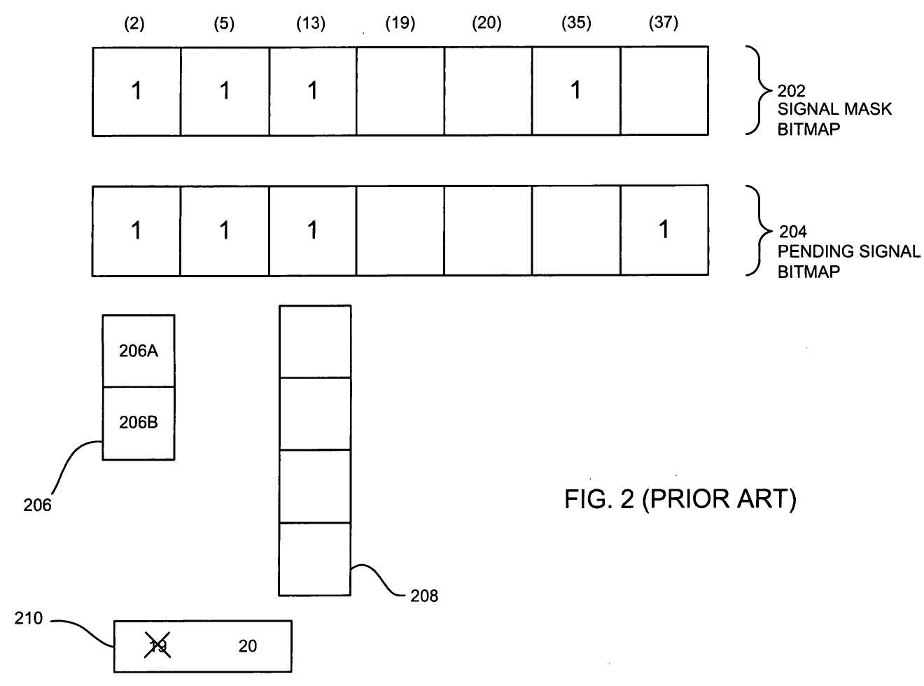

FIG. 3 illustrates an alterative prior art technique whereby multiple signals received after a client context enters its wait state are tracked.

FIG. 4 illustrates, in accordance with an embodiment of the present invention, how multiple signals received while the client context is in its wait mode may be handled.

FIG. 5 shows, in accordance with an embodiment of the present invention, an algorithm for managing one or more signals received while the client context is in its wait mode.

### DETAILED DESCRIPTION OF VARIOUS EMBODIMENTS

The present invention will now be described in detail with reference to various embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention may also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general purpose computer and/or a dedicated computing device when appropriately programmed and may include a combination of a computer/computing device and dedicated/programmable circuits adapted for the various tasks pertaining to embodiments of the invention.

In accordance with embodiments of the present invention, there are provided techniques for tracking the signals received while the client context is in its wait (sleep) state. In an embodiment, a single signal or multiple signals received by the client context while the client context is in its wait state are tracked using a pending signals bitmap. By tracking all signals received, these signals are acted upon at an appropriate time. Furthermore, by tracking these signals using the pending signals bitmap, which is visible to the normal signal delivery mechanism of the operating system, the pending state of these signals can be appropriately acted upon by other applications. This is unlike the situation in the prior art wherein the pending state of the signals are tracked in a separate saved signals bitmap (e.g., 302), which is not visible to the normal signal delivery mechanism.

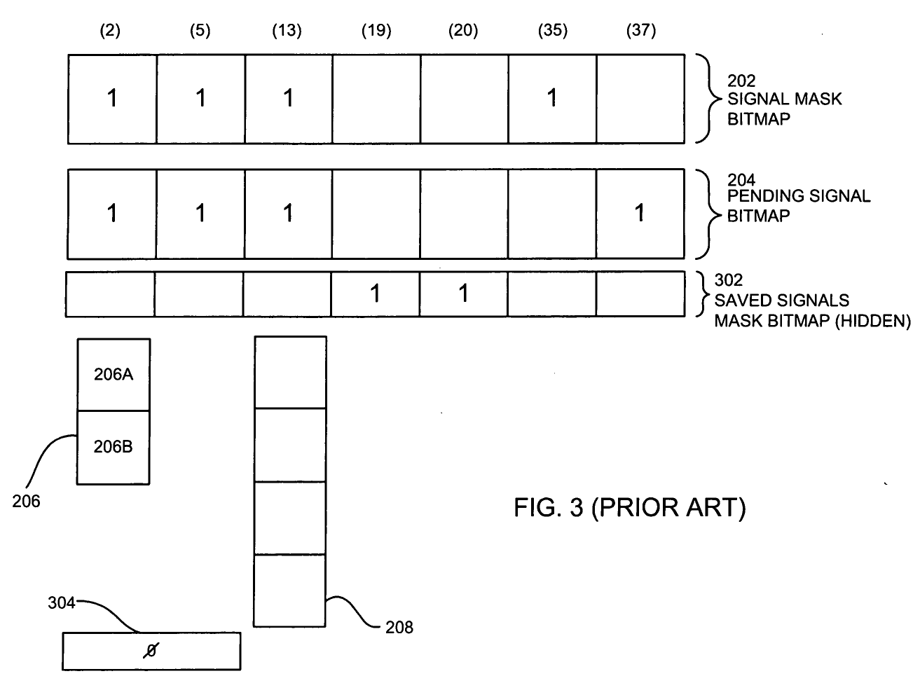

Furthermore, these signals are masked to prevent the client context from acting upon these signals while waiting for a response from the server context. The masking of a pending signal provides a further advantage in that since the signal is masked, subsequent instances of the same signal will be ignored by the client context. Accordingly, the client context does not need to suffer the inefficiency of continually sending requests to the server context, receiving responses from the server context, and/or setting the saved signals bitmap in the manner associated with the prior art of FIG. 3.

To facilitate cleaning up of intermediate states by the client context after the response is received from the server context, the original signal mask bitmap is stored away in a hidden original saved signal mask bitmap. The data in this hidden original saved signal mask bitmap is employed to restore the signal mask bitmap after the response is received from the server context, thereby allowing intermediate states to be resolved.

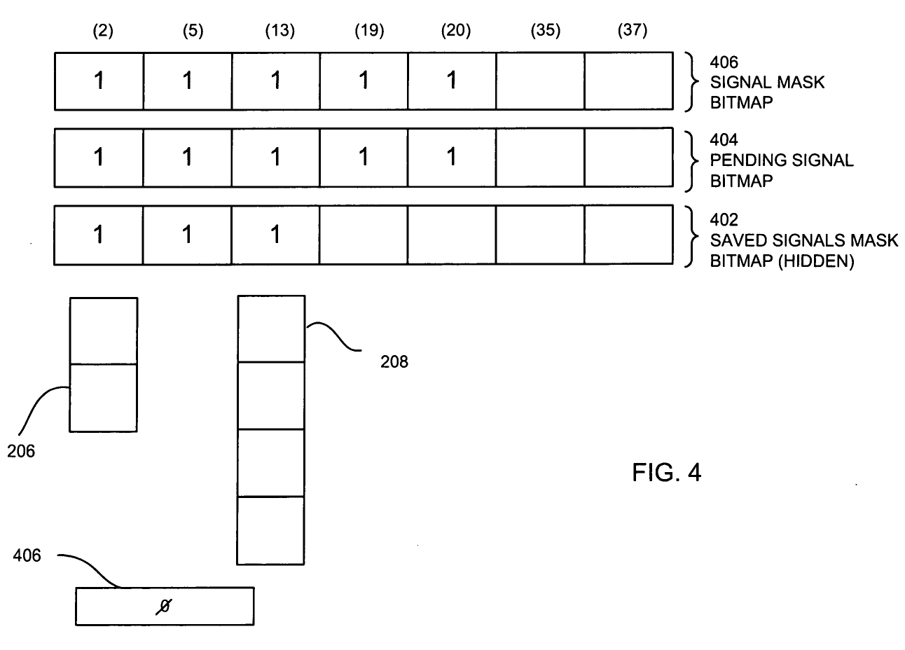

The features and advantages of the present invention may be better understood with reference to the figures and discussions that follow. FIG. 4 is an exemplar implementation wherein the original signal mask bitmap is saved when the client context enters its wait mode. In the example of FIG. 4, the original signal mask bitmap, which shows the bits associated with signals 2, 5, and 13 as masked, is saved when the client context enters its wait mode. The original signal mask bitmap 406 is saved into the saved signal mask bitmap 402. This data is preserved in a hidden state, as shown in FIG. 4.

Signals subsequently received by the client context (such as client context 114) are saved into the pending signals bitmap 404. Furthermore, the bits associated with those received signals are masked in signal mask bitmap 406. Thus, when signal 19 is received by the client context in its wait mode, the bits associated with signal 19 in both pending signals bitmap 404 and signal mask bitmap 406 are set. Likewise, when signal 20 is received by the client context in its wait mode, the bits associated with signal 20 in both pending signals bitmap 404 and signal mask bitmap 406 are set. After these bits are set for each signal, the signal is forwarded to the server context 122, and the value of current signal area 406 is returned to zero to indicate that no signal is currently acted upon by the client context.

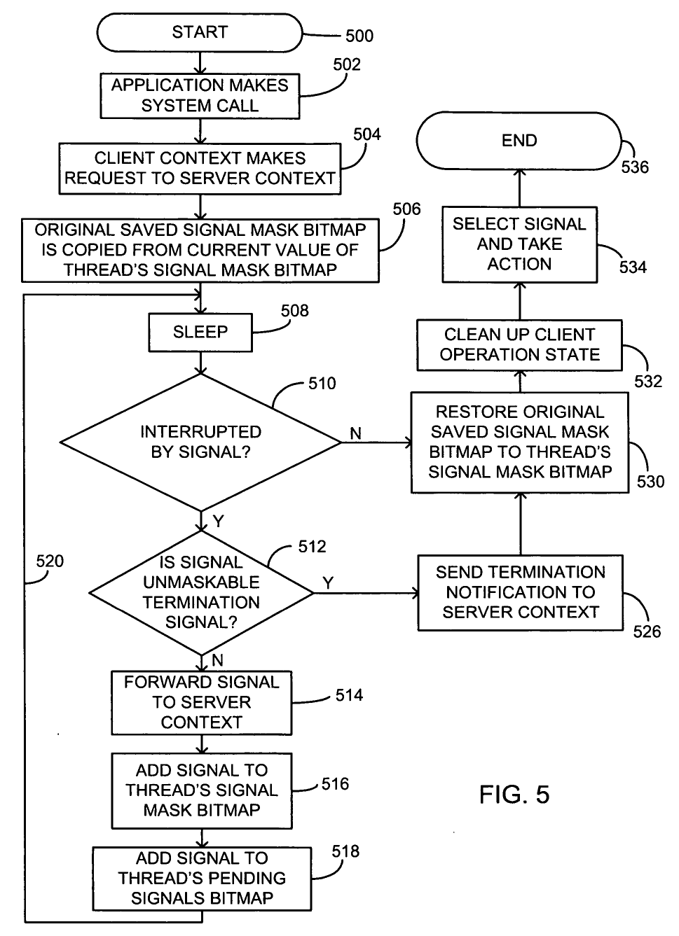

Since the bits associated with signals 19 and 20 are set in the pending signals bitmap 404, these signals are tracked as pending with client context 114. This data is visible to the normal signal delivery mechanism of the operating system, allowing the operating system to behave appropriately. Furthermore, the fact that these signals 19 and 20 are masked in signal mask bitmap 406 causes subsequent instances of these signals to be ignored by application thread 106. Thus, the inefficiency associated with the prior art of FIG. 3 is advantageously avoided. If the response from the server context is received, the response is handled as discussed below in connection with FIG. 5.

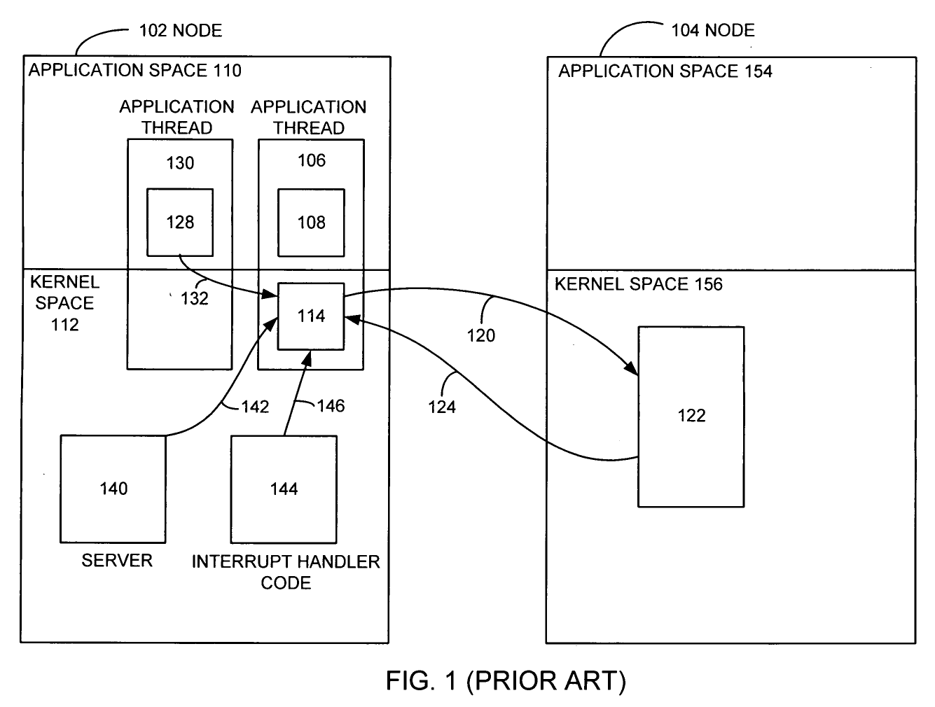

FIG. 5 shows, in accordance with an embodiment of the present invention, an algorithm for managing one or more signals received while the client context is in its wait mode. In step 502, the application makes a system function call. With reference to FIG. 1, this system function call represents system function call 108. In step 504, the client context 114 makes a request 120 to the server context 122. In step 506, the original saved signal bitmap 402 is copied from the thread's current signal mask bitmap 406 to preserve this data.

In step 508, the client context goes to sleep (wait state). In step 510, the client sleep has exited and an inquiry is made as to whether the exit is due to the a signal received (interruption) or due to a response from the server context. In the present example, suppose signal 19 is now received as an interruption. In this case, the method next proceeds to step 512 wherein an inquiry is made as to whether the signal received is an unmaskable termination signal. In Unix, some signals such as SIGKILL are unmaskable and thus must cause the client context to be terminated without further waits. So, a termination notification is sent to the server context in step 526. Assuming signal 19 is not an unmaskable termination signal, the signal received (19) is next forwarded to server context 122 in step 514 for handling.

In step 516, the signal 19 is added to the thread's signal mask bitmap (406 in FIG. 4). This has the effect of causing the client context to defer taking any action on signal 19. Further, this has the beneficial effect of preventing inefficient, repetitive operations when subsequent instances of signal 19 are received while the client context is in its wait mode. In step 518, the signal is added to the thread's pending signals bitmap 404. This allows the signal received (19) to be tracked and simultaneously allows signal 19 to be visible to the normal delivery mechanism of the OS.

Thereafter the method returns to step 508 via arrow 520.

The receipt of a subsequent signal 20 when the thread is in it wait mode causes the same steps to be executed again, resulting in signal 20 being masked in the thread's signal mask bitmap 406 and tracked in the pending signals bitmap 404.

Note again that the receipt of a subsequent instance of a signal already masked in the thread's signal mask bitmap (406) will not cause the client context to exit its sleep mode of step 508.

Assuming that the server context 122 returns a response 124 at some point in time, either because it has completed the required operation or because it has aborted, for example. The receipt of this response by the client context causes the sleep to exit, and is resolved in step 510 not to be a signal interruption that requires sending a notification to the server context. Thus, the method proceeds from step 510 to step 530 wherein the original saved signal mask bitmap 402 is saved back into the signal mask bitmap 406 to restore the thread's signal mask bitmap back to its original state. In step 532, the operation states of the client context can now be cleaned up. Thus, any intermediate state associated with the request made by the client context to the server context can now be cleaned up, for example.

In step 534, the kernel selects one of the pending signals listed in the thread's pending signals bitmap 404 and takes an appropriate action with respect to that signal, such as launching an application handler, for example. Note that the restoration of the original bitmap performed in step 530 earlier still left the signals received during the time the client context is in it wait mode as pending in the pending signals bitmap 404. These pending signals may now be handled in step 534. They are no longer masked by the signal mask bitmap 406.

As can be appreciated from the foregoing, embodiment of the invention track the signals received during the time the client context is in its wait mode in the pending signals bitmap so that these pending signals can be acted upon after the response from the server context is received. Further, by tracking these pending signals in the pending signals bitmap, these pending signals are tracked in a manner that is apparent to the normal signal delivery mechanism, allowing the normal signal delivery mechanism (and other applications) to function correctly. Additionally, the masking of these pending signals in the thread's signal mask bitmap advantageously prevents action from being taken on these pending signals by the client context as well as prevents inefficiency when instances of a signal already tracked and masked are received by the client context when the client context is in its wait mode.

While this invention has been described in terms of several embodiments, there are alterations, permutations, and equivalents which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A computer-implemented method for handling a first signal received at a client context, comprising:
saving a signal mask bitmap into a saved signal mask bitmap when said client context enters a wait mode, thereby preserving data in said signal mask bitmap;
masking said first signal in said signal mask bitmap, thereby causing said client context to defer taking action on said first signal; and
masking said first signal in a pending signals bitmap, thereby permitting said first signal to be tracked as pending with said client context.

2. The computer-implemented method of claim 1 further comprising:
forwarding said first signal to a server context;
receiving at said client context a first response from said server context, said first response representing a response by said server context to said first signal; and
restoring said signal mask bitmap with data stored in said saved signal mask bitmap responsive to said receiving said first response.

3. The computer-implemented method of claim 2 further comprising:
cleaning up intermediate states at said client context after said restoring; and
selecting a pending signal in said pending signals bitmap for handling.

4. The computer-implemented method of claim 3 wherein said handling includes launching an application handler.

5. The computer-implemented method of claim 1 wherein said pending signals bitmap is accessible to normal signal delivery mechanisms of an operating system that is responsible for executing said client context.

6. The computer-implemented method of claim 1 wherein an instance of a signal already masked in said signal mask bitmap does not, when received by said client context, cause a request to be sent to a server context.

7. The computer-implemented method of claim 1 further comprising:
forwarding said first signal to a server context;
receiving at said client context a second signal;
ascertaining whether said second signal represents a first response from said server context or another signal, said first response representing a response by said server context to a signal sent earlier from said client context; and
if said second signal represents said another signal, adding said another signal to both of said signal mask bitmap and said pending signals bitmap.

8. An article of manufacture comprising a program storage medium having computer readable code embodied therein, said computer readable code being configured for handling a first signal received at a client context, comprising:
computer readable code for saving a signal mask bitmap into a saved signal mask bitmap when said client context enters a wait mode, thereby preserving data in said signal mask bitmap;
computer readable code for masking said first signal in said signal mask bitmap, thereby causing said client context to defer taking action on said first signal; and
computer readable code for masking said first signal in a pending signals bitmap, thereby permitting said first signal to be tracked as pending with said client context.

9. The article of manufacture of claim 8 further comprising:
computer readable code for forwarding said first signal to a server context;
computer readable code for receiving at said client context a first response from said server context, said first response representing a response by said server context to said first signal; and
computer readable code for restoring said signal mask bitmap with data stored in said saved signal mask bitmap responsive to said receiving said first response.

10. The article of manufacture of claim 9 further comprising:
computer readable code for cleaning up intermediate states at said client context after said restoring; and
computer readable code for selecting a pending signal in said pending signals bitmap for handling.

11. The article of manufacture of claim 10 wherein said handling includes launching an application handler.

12. The article of manufacture of claim 8 wherein said pending signals bitmap is accessible to normal signal delivery mechanisms of an operating system that is responsible for executing said client context.

13. The article of manufacture of claim 8 wherein an instance of a signal already masked in said signal mask bitmap does not, when received by said client context, cause a request to be sent to a server context.

14. The article of manufacture of claim 8 further comprising:
computer readable code for forwarding said first signal to a server context;
computer readable code for receiving at said client context a second signal;
computer readable code for ascertaining whether said second signal represents a first response from said server context or another signal, said first response representing a response by said server context to a signal sent earlier from said client context; and
computer readable code for adding, if said second signal represents said another signal, said another signal to both of said signal mask bitmap and said pending signals bitmap.

15. A computer-implemented method for handling a first signal received at a client context, said client context residing in a kernel space of an operating system of a client computer node, comprising:
copying a signal mask bitmap into a saved signal mask bitmap when said client context enters a wait mode, thereby preserving data in said signal mask bitmap;
receiving said first signal;
if said first signal is a signal requiring said client context to request handling by a server context, performing steps a), b), and c) wherein
a) forwarding said first signal to a server context for handling;
b) masking said first signal in said signal mask bitmap, thereby causing said client context to defer taking action on said first signal; and
c) masking said first signal in a pending signals bitmap, thereby permitting said first signal to be tracked as pending with said client context, said client context ignoring, when said first signal is tracked in said pending signals bitmap, subsequently received signals pertaining to instances of said first signal.

16. The computer-implemented method of claim 15 further comprising:
receiving at said client context a first response from said server context, said first response representing a response by said server context to said first signal; and
restoring said signal mask bitmap with data stored in said saved signal mask bitmap responsive to said receiving said first response.

17. The computer-implemented method of claim 16 further comprising:
cleaning up intermediate states at said client context after said restoring; and
selecting a pending signal in said pending signals bitmap for handling.

18. The computer-implemented method of claim 17 wherein said handling includes launching an application handler.

19. The computer-implemented method of claim 15 wherein said pending signals bitmap is accessible to normal signal delivery mechanisms of an operating system that is responsible for executing said client context.
